(19) United States
(12) Patent Application Publication
(10) Pub. No.: US 2025/0079852 A1
(43) Pub. Date: Mar. 6, 2025

(54) INTELLIGENT DUO-C ADAPTER POWER MANAGEMENT WITH STREAMLINED ARCHITECTURE DESIGN

(71) Applicant: DELL PRODUCTS L.P., Round Rock, TX (US)

(72) Inventors: Tsung-Cheng Liao, Taoyuan City (TW); Wei-Cheng Yu, New Taipei City (TW); Merle Jackson Wood III, Round Rock, TX (US); Chin Jui Liu, Taoyuan City (TW); Tun-Chieh Liang, Taipei City (TW); Chi-Che Wu, Taipei (TW)

(21) Appl. No.: 18/462,344

(22) Filed: Sep. 6, 2023

(51) Int. Cl. H02J 7/00

(52) U.S. Cl. CPC H02J 7/0013; H02J 7/00032; H02J 7/0036; H02J 7/007192; H02J 2207/20; H02M 3/158; H02M 3/33507

(57) ABSTRACT

A power adapter includes a flyback converter and a buck converter. If a first device is a preferred device, then power is allocated to the first device up to a first value. If a second device is plugged in, then power is re-allocating to the first device up to a second value and up to a third value to the second device. A total of the second value and the third value is up to the first value.

### FIELD OF THE DISCLOSURE

The present disclosure generally relates to information handling systems, and more particularly relates to intelligent duo-c adapter power management with streamlined architecture design.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

A power adapter includes a flyback converter and a buck converter. If a first device is a preferred device, then power is allocated to the first device up to a first value. If a second device is plugged in, then power is re-allocating to the first device up to a second value and up to a third value to the second device. A total of the second value and the third value is up to the first value.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system according to an embodiment of the present disclosure;

FIG. 2 is a perspective view of a computing environment, according to an embodiment of the present disclosure;

FIGS. 3, 4, 5, and 6 are flowcharts of a method for intelligent power management of a power adapter, according to an embodiment of the present disclosure;

FIGS. 7 and 8 show relationships between temperature of the power adapter voltage/current and system battery charge level of plugged-in electronic devices, according to an embodiment of the present disclosure;

FIG. 9 shows a power adapter circuit, according to an embodiment of the present disclosure; and

FIG. 10 is a table which includes the status of metal oxide silicon field effect transistors based on various states of the ports of the power adapter.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

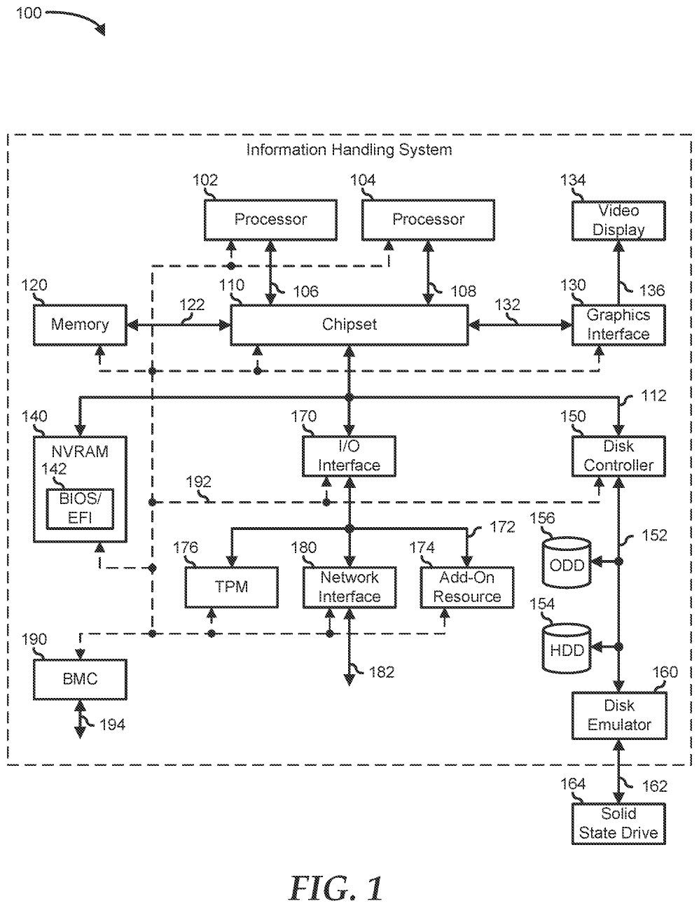

FIG. 1 illustrates an embodiment of an information handling system 100 including processors 102 and 104, a chipset 110, a memory 120, a graphics adapter 130 connected to a video display 134, a non-volatile RAM (NV-RAM) 140 that includes a basic input and output system/extensible firmware interface (BIOS/EFI) module 142, a disk controller 150, a hard disk drive (HDD) 154, an optical disk drive 156, a disk emulator 160 connected to a solid-state drive (SSD) 164, an input/output (I/O) interface 170 connected to an add-on resource 174 and a trusted platform module (TPM) 176, a network interface 180, and a baseboard management controller (BMC) 190. Processor 102 is connected to chipset 110 via processor interface 106, and processor 104 is connected to the chipset via processor interface 108. In a particular embodiment, processors 102 and 104 are connected together via a high-capacity coherent fabric, such as a HyperTransport link, a QuickPath Interconnect, or the like. Chipset 110 represents an integrated circuit or group of integrated circuits that manage the data flow between processors 102 and 104 and the other elements of information handling system 100. In a particular embodiment, chipset 110 represents a pair of integrated circuits, such as a northbridge component and a southbridge component. In another embodiment, some or all of the functions and features of chipset 110 are integrated with one or more of processors 102 and 104.

Memory 120 is connected to chipset 110 via a memory interface 122. An example of memory interface 122 includes a Double Data Rate (DDR) memory channel and memory 120 represents one or more DDR Dual In-Line Memory Modules (DIMMs). In a particular embodiment, memory interface 122 represents two or more DDR channels. In another embodiment, one or more of processors 102 and 104 include a memory interface that provides a dedicated memory for the processors. A DDR channel and the connected DDR DIMMs can be in accordance with a particular DDR standard, such as a DDR3 standard, a DDR4 standard, a DDR5 standard, or the like.

Memory 120 may further represent various combinations of memory types, such as Dynamic Random Access Memory (DRAM) DIMMs, Static Random Access Memory (SRAM) DIMMs, non-volatile DIMMs (NV-DIMMs), storage class memory devices, Read-Only Memory (ROM) devices, or the like. Graphics adapter 130 is connected to chipset 110 via a graphics interface 132 and provides a video display output 136 to a video display 134. An example of a graphics interface 132 includes a Peripheral Component Interconnect-Express (PCIe) interface and graphics adapter 130 can include a four-lane (×4) PCIe adapter, an eight-lane (×8) PCIe adapter, a 16-lane (×16) PCIe adapter, or another configuration, as needed or desired. In a particular embodiment, graphics adapter 130 is provided down on a system printed circuit board (PCB). Video display output 136 can include a Digital Video Interface (DVI), a High-Definition Multimedia Interface (HDMI), a DisplayPort interface, or the like, and video display 134 can include a monitor, a smart television, an embedded display such as a laptop computer display, or the like.

NV-RAM 140, disk controller 150, and I/O interface 170 are connected to chipset 110 via an I/O channel 112. An example of I/O channel 112 includes one or more point-to-point PCIe links between chipset 110 and each of NV-RAM 140, disk controller 150, and I/O interface 170. Chipset 110 can also include one or more other I/O interfaces, including a PCIe interface, an Industry Standard Architecture (ISA) interface, a Small Computer Serial Interface (SCSI) interface, an Inter-Integrated Circuit (I2C) interface, a System Packet Interface (SPI), a Universal Serial Bus (USB), another interface, or a combination thereof. NV-RAM 140 includes BIOS/EFI module 142 that stores machine-executable code (BIOS/EFI code) that operates to detect the resources of information handling system 100, to provide drivers for the resources, to initialize the resources, and to provide common access mechanisms for the resources. The functions and features of BIOS/EFI module 142 will be further described below.

Disk controller 150 includes a disk interface 152 that connects the disc controller to a hard disk drive (HDD) 154, to an optical disk drive (ODD) 156, and to disk emulator 160. An example of disk interface 152 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 160 permits SSD 164 to be connected to information handling system 100 via an external interface 162. An example of external interface 162 includes a USB interface, an institute of electrical and electronics engineers (IEEE) 1394 (Firewire) interface, a proprietary interface, or a combination thereof. Alternatively, SSD 164 can be disposed within information handling system 100.

I/O interface 170 includes a peripheral interface 172 that connects the I/O interface to add-on resource 174, to TPM 176, and to network interface 180. Peripheral interface 172 can be the same type of interface as I/O channel 112 or can be a different type of interface. As such, I/O interface 170 extends the capacity of I/O channel 112 when peripheral interface 172 and the I/O channel are of the same type, and the I/O interface translates information from a format suitable to the I/O channel to a format suitable to the peripheral interface 172 when they are of a different type. Add-on resource 174 can include a data storage system, an additional graphics interface, a network interface card (NIC), a sound/video processing card, another add-on resource, or a combination thereof. Add-on resource 174 can be on a main circuit board, on separate circuit board, or add-in card disposed within information handling system 100, a device that is external to the information handling system, or a combination thereof.

Network interface 180 represents a network communication device disposed within information handling system 100, on a main circuit board of the information handling system, integrated onto another component such as chipset 110, in another suitable location, or a combination thereof. Network interface 180 includes a network channel 182 that provides an interface to devices that are external to information handling system 100. In a particular embodiment, network channel 182 is of a different type than peripheral interface 172, and network interface 180 translates information from a format suitable to the peripheral channel to a format suitable to external devices.

In a particular embodiment, network interface 180 includes a NIC or host bus adapter (HBA), and an example of network channel 182 includes an InfiniBand channel, a Fibre Channel, a Gigabit Ethernet channel, a proprietary channel architecture, or a combination thereof. In another embodiment, network interface 180 includes a wireless communication interface, and network channel 182 includes a Wi-Fi channel, a near-field communication (NFC) channel, a Bluetooth® or Bluetooth-Low-Energy (BLE) channel, a cellular based interface such as a Global System for Mobile (GSM) interface, a Code-Division Multiple Access (CDMA) interface, a Universal Mobile Telecommunications System (UMTS) interface, a Long-Term Evolution (LTE) interface, or another cellular based interface, or a combination thereof. Network channel 182 can be connected to an external network resource (not illustrated). The network resource can include another information handling system, a data storage system, another network, a grid management system, another suitable resource, or a combination thereof.

BMC 190 is connected to multiple elements of information handling system 100 via one or more management interface 192 to provide out of band monitoring, maintenance, and control of the elements of the information handling system. As such, BMC 190 represents a processing device different from processor 102 and processor 104, which provides various management functions for information handling system 100. For example, BMC 190 may be responsible for power management, cooling management, and the like. The term BMC is often used in the context of server systems, while in a consumer-level device, a BMC may be referred to as an embedded controller (EC). A BMC included at a data storage system can be referred to as a storage enclosure processor. A BMC included at a chassis of a blade server can be referred to as a chassis management controller and embedded controllers included at the blades of the blade server can be referred to as blade management controllers. Capabilities and functions provided by BMC 190 can vary considerably based on the type of information handling system. BMC 190 can operate in accordance with an Intelligent Platform Management Interface (IPMI). Examples of BMC 190 include an Integrated DellR Remote Access Controller (iDRAC).

Management interface 192 represents one or more out-of-band communication interfaces between BMC 190 and the elements of information handling system 100, and can include a I2C bus, a System Management Bus (SMBus), a Power Management Bus (PMBUS), a Low Pin Count (LPC) interface, a serial bus such as a USB or a Serial Peripheral Interface (SPI), a network interface such as an Ethernet interface, a high-speed serial data link such as a PCIe interface, a Network Controller Sideband Interface (NC-SI), or the like. As used herein, out-of-band access refers to operations performed apart from a BIOS/operating system execution environment on information handling system 100, that is apart from the execution of code by processors 102 and 104 and procedures that are implemented on the information handling system in response to the executed code.

BMC 190 operates to monitor and maintain system firmware, such as code stored in BIOS/EFI module 142, option ROMs for graphics adapter 130, disk controller 150, add-on resource 174, network interface 180, or other elements of information handling system 100, as needed or desired. In particular, BMC 190 includes a network interface 194 that can be connected to a remote management system to receive firmware updates, as needed or desired. Here, BMC 190 receives the firmware updates, stores the updates to a data storage device associated with the BMC, transfers the firmware updates to NV-RAM of the device or system that is the subject of the firmware update, thereby replacing the currently operating firmware associated with the device or system, and reboots information handling system, whereupon the device or system utilizes the updated firmware image.

BMC 190 utilizes various protocols and application programming interfaces (APIs) to direct and control the processes for monitoring and maintaining the system firmware. An example of a protocol or API for monitoring and maintaining the system firmware includes a graphical user interface (GUI) associated with BMC 190, an interface defined by the Distributed Management Taskforce (DMTF) (such as a Web Services Management (WSMan) interface, a Management Component Transport Protocol (MCTP) or, a RedfishR interface), various vendor defined interfaces (such as a Dell EMC Remote Access Controller Administrator (RACADM) utility, a Dell EMC OpenManage Enterprise, a Dell EMC OpenManage Server Administrator (OMSA) utility, a Dell EMC OpenManage Storage Services (OMSS) utility, or a Dell EMC OpenManage Deployment Toolkit (DTK) suite), a BIOS setup utility such as invoked by a “F2” boot option, or another protocol or API, as needed or desired.

In a particular embodiment, BMC 190 is included on a main circuit board (such as a baseboard, a motherboard, or any combination thereof) of information handling system 100 or is integrated onto another element of the information handling system such as chipset 110, or another suitable element, as needed or desired. As such, BMC 190 can be part of an integrated circuit or a chipset within information handling system 100. An example of BMC 190 includes an iDRAC, or the like. BMC 190 may operate on a separate power plane from other resources in information handling system 100. Thus BMC 190 can communicate with the management system via network interface 194 while the resources of information handling system 100 are powered off. Here, information can be sent from the management system to BMC 190 and the information can be stored in a RAM or NV-RAM associated with the BMC. Information stored in the RAM may be lost after power-down of the power plane for BMC 190, while information stored in the NV-RAM may be saved through a power-down/power-up cycle of the power plane for the BMC.

Information handling system 100 can include additional components and additional busses, not shown for clarity. For example, information handling system 100 can include multiple processor cores, audio devices, and the like. While a particular arrangement of bus technologies and interconnections is illustrated for the purpose of example, one of skill will appreciate that the techniques disclosed herein are applicable to other system architectures. Information handling system 100 can include multiple central processing units (CPUs) and redundant bus controllers. One or more components can be integrated together. Information handling system 100 can include additional buses and bus protocols, for example, I2C and the like. Additional components of information handling system 100 can include one or more storage devices that can store machine-executable code, one or more communications ports for communicating with external devices, and various input and output (I/O) devices, such as a keyboard, a mouse, and a video display.

For purposes of this disclosure information handling system 100 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 100 can be a personal computer, a laptop computer, a smartphone, a tablet device or other consumer electronic device, a network server, a network storage device, a switch, a router, or another network communication device, or any other suitable device and may vary in size, shape, performance, functionality, and price. Further, information handling system 100 can include processing resources for executing machine-executable code, such as processor 102, a programmable logic array (PLA), an embedded device such as a System-on-a-Chip (SoC), or other control logic hardware. Information handling system 100 can also include one or more computer-readable media for storing machine-executable code, such as software or data.

Portable information handling systems such as laptop computers, tablet computers, and smartphones are designed to operate on direct current (DC) battery power. When such systems are plugged in to alternating current (AC) power supplied by a wall outlet, an external power supply or AC-DC power adapter is commonly used to convert the AC power received from the wall outlet into DC. Power supply units, including AC power adapters, have a maximum power rating such as 30 watts, 45 watts, 65 watts, or 90 watts. This rating normally is specified along with a normative current and voltage output, or range of current/voltage outputs. Dual AC power adapters, also referred to simply as power adapters, typically offer assigned power profiles, wherein a power allocation is assigned to a port.

However, this may cause an unfavorable user experience if the user did not follow instructions when plugging in a device. In addition to the assigned power allocation, the dual power adapter typically offers a fixed power profile, by assigning a fixed power allocation to the port. For example, port one may be assigned a maximum of 45 watts while port two may be assigned a maximum of 15 watts. As such, this may result in various issues when a user plugs a device that requires more than 15 watts to port two instead of port one. For example, the user may receive a message about an “undersized adapter” or a “potential battery drain.” To address these and other needs, the present disclosure provides intelligent and streamlined power management of power adapters that allows the user to plug the device at any port.

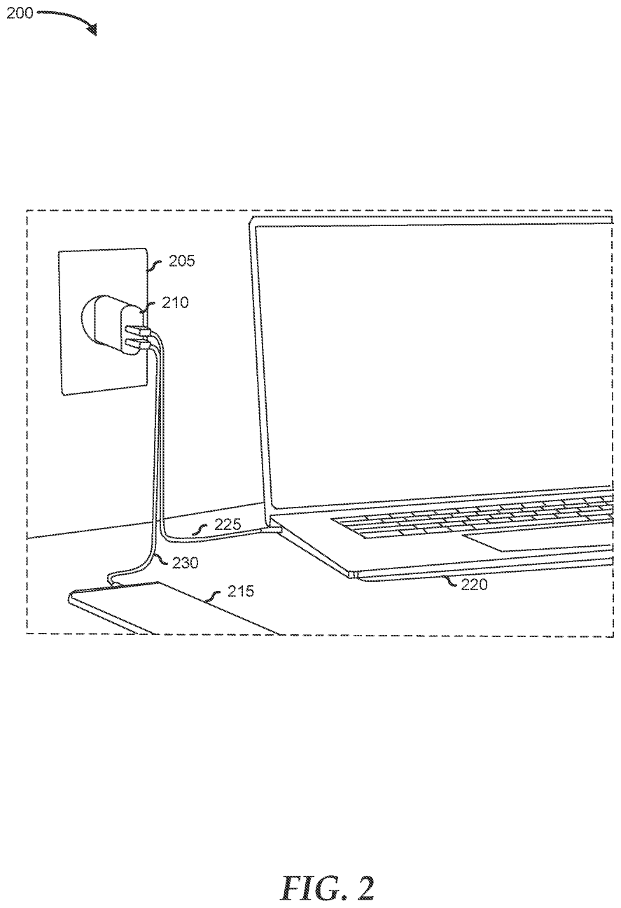

FIG. 2 shows a perspective view of a computing environment 200. Computing environment 200 includes a power supply 205, a power adapter 210, an information handling system 215, and an information handling system 220. Information handling system 215 may be similar to information handling system 100 of FIG. 1. Information handling systems 215 and 220 may be coupled to power adapter 210 via cables 225 and 230 respectively. Power adapter 210 may be coupled to power supply 205. Power adapter 210 may also be referred to as a source, while information handling systems 215 and 220 may be referred to as sinks. In other embodiments, computing environment 200 may include additional, fewer, and/or different components than shown in FIG. 2.

Power supply 205 may be a suitable system, apparatus, or device, operable to provide power to one or more components of computing environment 200. Specifically power supply 205, may be or include an AC power outlet operable to provide AC power to power adapter 210. For example, power adapter 210 may be coupled to power supply 205 via prongs disposed on a wall-mounted plate of power supply 205.

Power adapter 210 may be a suitable system, apparatus, or device operable to provide power to information handling systems 215 and 220. In particular, power adapter 210 may be operable to convert AC power received from power supply 205 to a DC power to be provided to, and consumed by information handling systems 215 and 220. In one embodiment, power adapter 210 may include two or more ports, wherein one end of a cable may be plugged into a port and another end of the cable may be plugged into a port of information handling system 215 or information handling system 220. In this example, information handling system 215 is plugged into one port of power adapter 210 via a cable, and information handling system 220 is plugged into another port of power adapter 210 via another cable. This allows information handling systems 215 and 220 to be charged simultaneously.

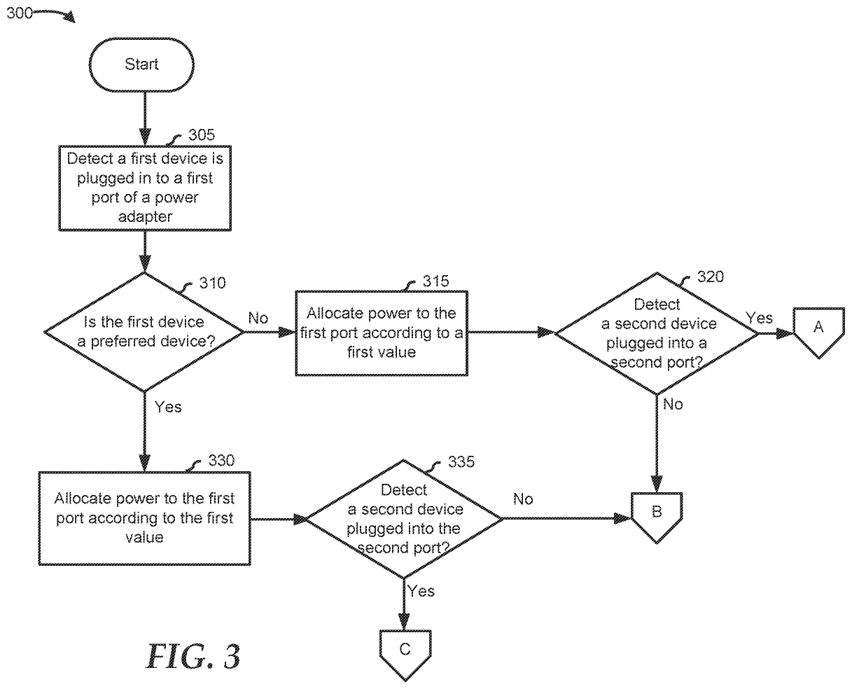

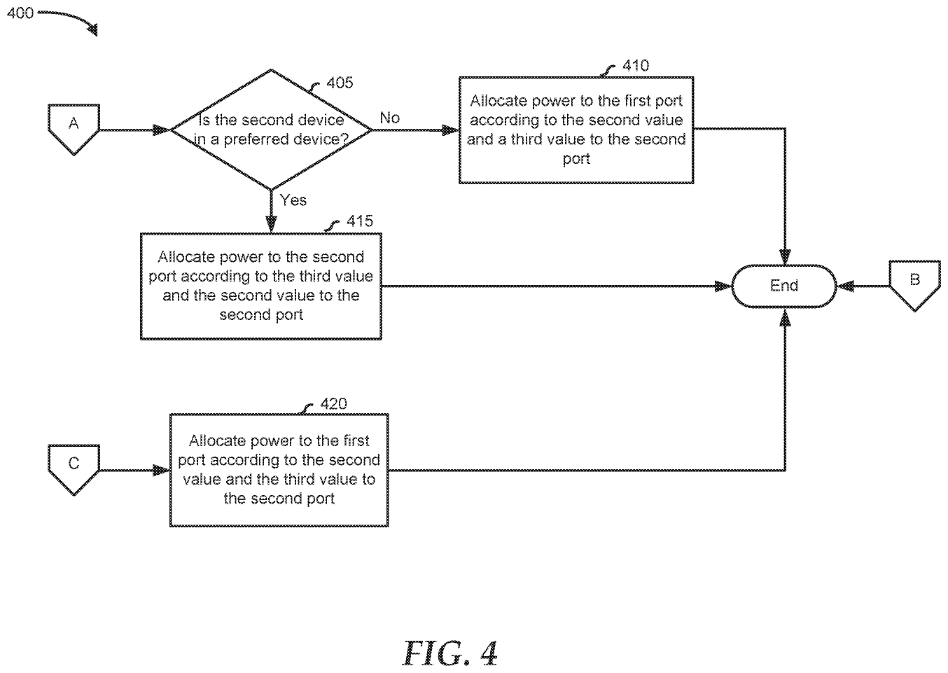

Power adapter 210 may be configured to automatically recognize whether a device plugged in is a preferred device. A preferred device may be manufactured by a particular manufacturer. If the device is a preferred device, then power allocation to the preferred device may be prioritized over the non-preferred device as depicted in FIG. 3 and FIG. 4. For example, if the maximum power that can be allocated to the devices is 60 watts, then 45 watts or 75% of the maximum power can be allocated to the preferred device and the remaining power can be allocated to the non-preferred device.

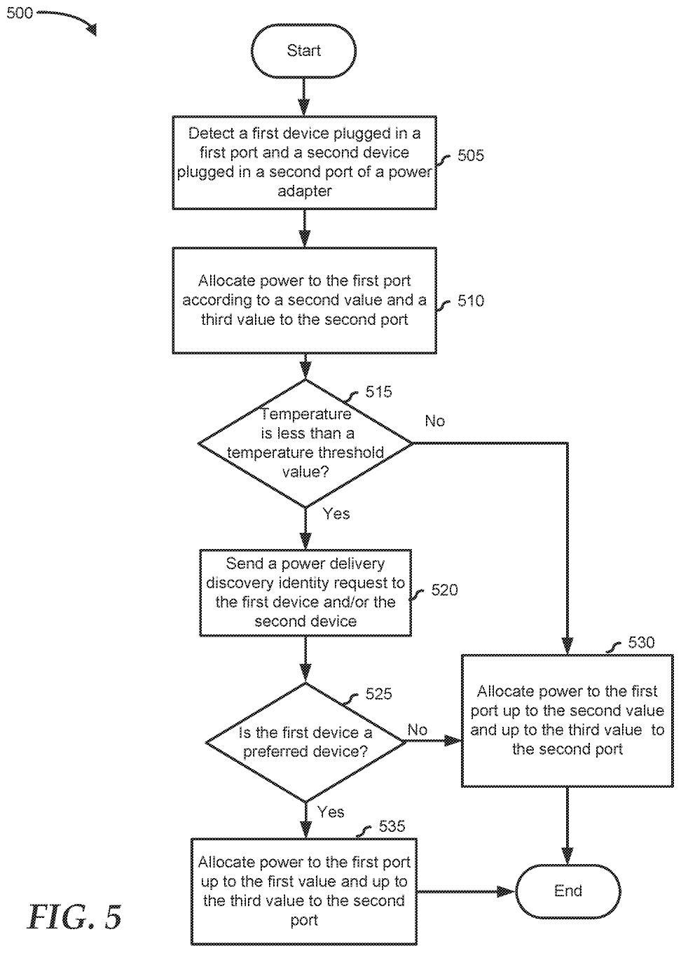

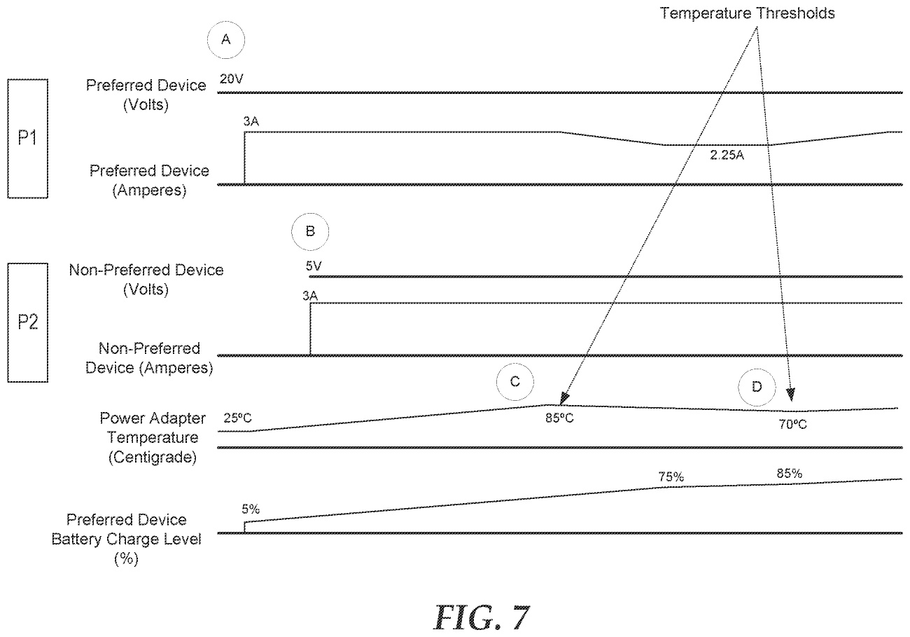

Power adapter 210 may also be configured to dynamically keep thermals under or at allowed values. Power allocation to the devices plugged may be provided and maintained at maximum allowable values until a thermal threshold is met. If the device reaches a temperature threshold, the power allocation may be renegotiated such that power provided to the devices may be reduced to lower the current temperature of power adapter 210 as depicted in FIG. 5 and FIG. 7.

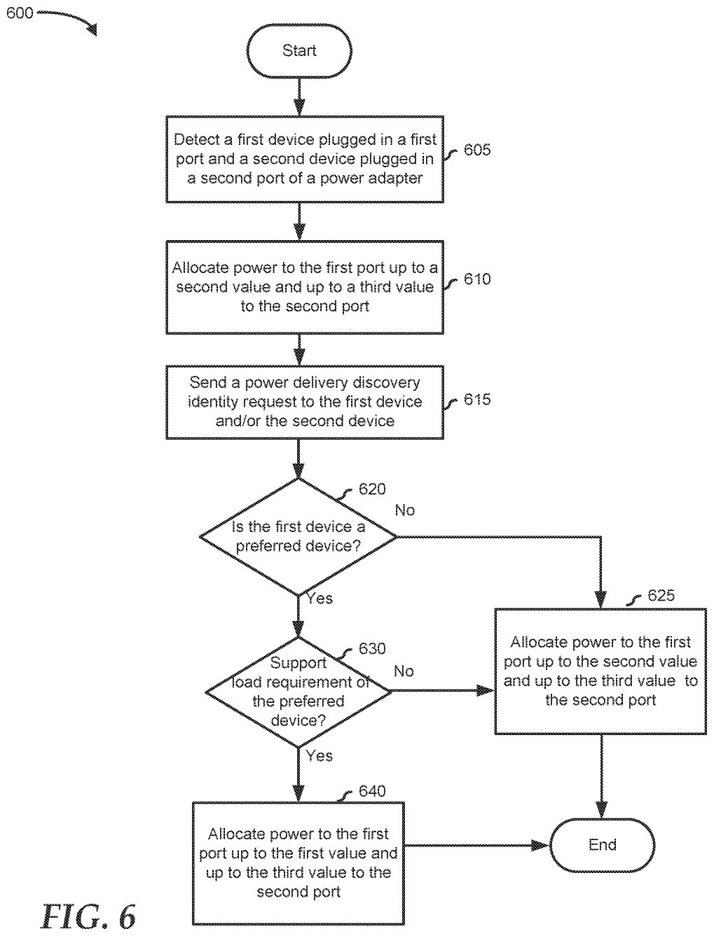

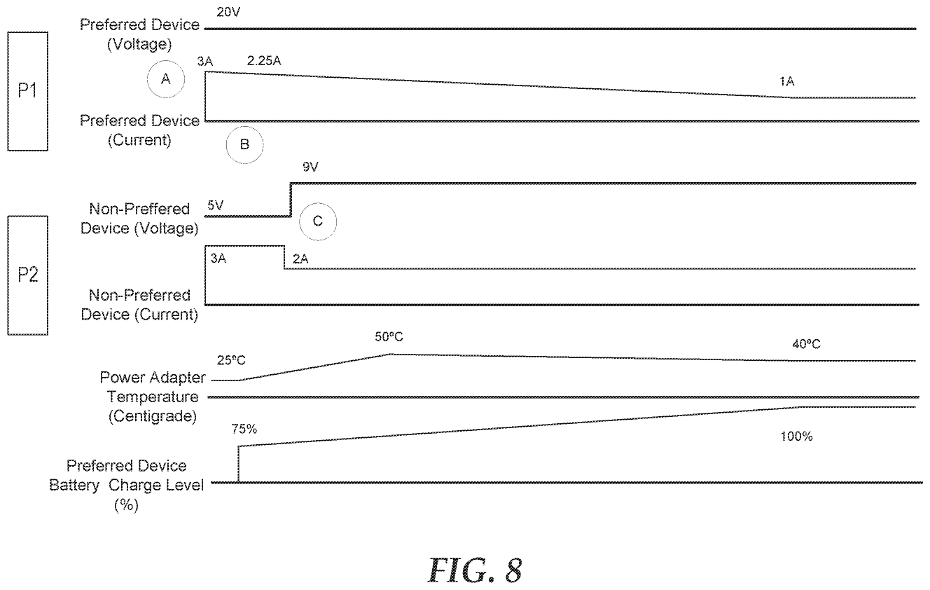

Power adapter 210 may also be configured to renegotiate power allocation when power consumption of a device is lower than the power allocated to it. Power adapter 210 may provide the delta to the other device as depicted in FIG. 6 and FIG. 8. For example, when power adapter 210 detects the second device, power adapter 210 may perform one of two actions: a first action is to reduce the power allocated to the first device to a pre-determined second value, a second action is to determine whether the first device is consuming the power initially allocated to it. If the first device is not consuming the allocated power then re-negotiate power allocation and allocate less power to the first device, such as up to the power consumed, and provide the available power to the second device.

Each of the ports of power adapter 210 may be capable of operating in a high-power mode and a low-power mode. When operating in a high-power mode, the port can charge an information handling system that requires higher power, such as information handling system 220 which can be a portable information handling system, such as a laptop, a notebook, a tablet, or similar. When operating in a low-power mode the port can charge an information handling system that requires lower power, such as information handling system 215 which can be a mobile information handling system, such as a smartphone, a smartwatch, or similar. For example, in a high-power mode, the port can allocate power up to 60 watts and 15 watts or less while in a low-power mode. The port can automatically switch from high-power mode to low-power mode dynamically.

In this example, information handling system 220 may be drawing higher power from one of the ports of power adapter 210 in comparison to information handling system 215. Although information handling system 220 is plugged into a first port of the power adapter and information handling system 215 is plugged into a second port, these information handling systems may be plugged into the other port. For example, information handling system 220 may be plugged into the second port while information handling system 215 is plugged into the first port.

Power adapter 210 may be a USB type-C power adapter, a mini-USB power adapter, a micro-USB power adapter, or similar. Although power adapter 210 is shown with two ports, power adapter 210 may include more than two ports. In addition, one or both of the ports may be a USB-C port, a Thunderbolt™ port, a DisplayPort™ port, or similar. The ports may be a combination of different types, such as one is a USB-C port while another port is a DisplyPort™. Further, the ports may be compliant with power delivery specifications for delivery of up to 100 watts suitable to various devices, such as information handling systems, battery chargers, alarms, etc.

The system and method described herein may automatically configure the ports on the power adapter, thereby providing users with a “plug and play” functionality. Instead of placing the burden on the consumer to determine which port is configured with a higher power allocation, the power adapter may automatically configure the port when an external device is coupled to the port. For example, when a user plugs a cable that is coupled to an external device into the port, the power adapter may communicate with the external device and determine the power requirement of the external device, and allocates power to the port based on the power requirement of the external device.

Power adapter 210 may include a custom logic device, such as an integrated circuit or the like. This custom logic device may be implemented using one or more technologies, such as an embedded controller, field programmable gate array (FPGA), microcontroller with custom firmware, or another programmable logic device, which may monitor the internal communication between the external device coupled with the ports of the power adapter. When an external device is attached, such as via a cable, to one of the ports, the custom logic device may monitor the port to determine the power requirement of the external device.

The custom logic device may use a power delivery communication protocol for connection and/or communication between the power adapter and power delivery-aware electronic devices, such as information handling systems 220 and 215. The custom logic device may implement a flexible power management scheme through a bi-directional data channel. For example, power adapter 210 may transmit a power delivery object (PDO) that provides information on voltages and/or currents it can deliver. In one example embodiment, the PDO may indicate that it can indicate the voltages at certain amperes it can deliver, such as 5 volts, 9 volts, 15 volts, or 20 volts at 3 amperes. Meanwhile, the electronic device may send a request data object (RDO) that indicates desired voltage and/or current, which may be one of the indicated voltages and amperes by the PDO. Power adapter 210 may accept or reject the request. A renegotiation may occur between the power adapter and the devices from time to time.

Those of ordinary skill in the art will appreciate that the configuration, hardware, and/or software components of computing environment 200 depicted in FIG. 2 may vary. For example, the illustrative components within computing environment 200 are not intended to be exhaustive but rather are representative to highlight components that can be utilized to implement aspects of the present disclosure. For example, other devices and/or components may be used in addition to or in place of the devices/components depicted. The depicted example does not convey or imply any architectural or other limitations with respect to the presently described embodiments and/or the general disclosure. In the discussion of the figures, reference may also be made to components illustrated in other figures for continuity of the description.

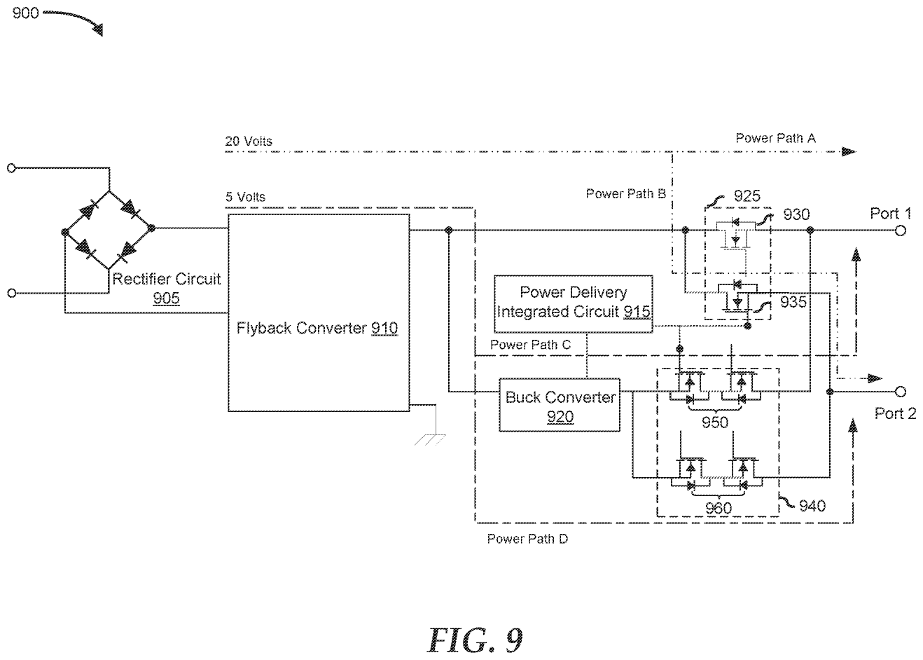

FIG. 3 shows a flowchart of a method 300 for intelligent power management of a power adapter. Method 300 may be performed by one or more components of the power adapter, such as a power delivery integrated circuit of 915 of FIG. 9 to monitor and manage power delivery or power allocation to one or more ports of the power adapter. While embodiments of the present disclosure are described in terms of the circuitry of power adapter 900 as shown in FIG. 9, it should be recognized that other systems may be utilized to perform the described method. One of skill in the art will appreciate that this flowchart explains a typical example, which can be extended to advanced applications or services in practice.

The method typically starts block 305, where the power adapter detects that a device is connected to or plugged into its first port. The method may proceed to decision block 310, where the power delivery integrated circuit determines whether the device is a preferred device, wherein the device is from a preferred manufacturer or vendor that is pre-defined. For example, the manufacturer or vendor of the preferred device is the same manufacturer or vendor as the power adapter. In addition, the power adapter and the preferred device may be capable of power delivery.

If the device is a preferred device, then the “YES” branch is taken and the method proceeds to block 330. If the device is not a preferred device, then the “NO” branch is taken and the method proceeds to block 315. At block 315, the method may initially allocate power to the first port of the power adapter according to a first value. In one example, the first value may be equal to 60 watts. The first value may be a standard maximum power that the power adapter can provide for an extended period. The power adapter may transmit the PDO that indicates it can deliver 5 volts, 9 volts, 15 volts, or 20 volts at 3 amperes. The first device may send the RDO that indicates a desired voltage and/or current. In this example, if the power provided by the power adapter is up to the first value, then the power may take a power path “A” as indicated in FIG. 9.

The method may proceed to decision block 320 where the power adapter may determine whether it detects a second device that is plugged into a second port of the power adapter. If the power adapter detects the second device, then the “YES” branch is taken and the method proceeds to decision block 405. If the power adapter does not detect the second device, then the “NO” branch is taken and the method ends.

At block 330, the method may allocate power to the first port of the power adapter according to the first value. The method proceeds to decision block 335 where the power adapter may determine whether it detects a second device plugged into the second port of the Power adapter. If the power adapter detects the second device, then the “YES” branch is taken and the method proceeds to block 420 of FIG. 4. If the power adapter does not detect the second device, then the “NO” branch is taken and the method ends.

FIG. 4 shows a flowchart of a method 400 which is a continuation of method 300 of FIG. 3. At decision block 405, the method may determine whether the second device is a preferred device. If the second device is a preferred device, then the “YES” branch is taken and the method proceeds to block 415. If the second device is not a preferred device, then the “NO” branch is taken and the method proceeds to block 410. At block 410, the method may allocate power to the first port of the power adapter up to a second value. The method may allocate power to the second port of the power adapter up to a third value. The second value and the third value may be a fraction of the first value, wherein the third value is less than the second value. In one example, the second value may be 75% of the first value and the third value is a third of the second value, wherein the second value plus the third value equals the first value. For example, if the first value is 60 watts, then the second value may be equal to 45 watts while the third value may be equal to 15 watts. The power adapter may transmit a PDO that includes 5 volts, 9 volts, 15 volts, and 20 volts at 3 amperes to the first device. The power provided via the first port may take a power path “A” as shown in FIG. 9. The power adapter may transmit a PDO that includes 5 volts and 9 volts at 3 amperes to the second device. The power provided via the second port may take a power path “D” as shown in FIG. 9.

At block 415, the method may allocate power to the first port up to a third value. The method may allocate power to the second port up to a second value. The power adapter may transmit a PDO that includes 5 volts and 9 volts at 3 amperes to the first device. The power provided via the first port may take a power path “C” as shown in FIG. 9. The power adapter may transmit a PDO that includes 5 volts, 9 volts, 15 volts, and 20 volts at 3 amperes to the second device. The power provided via the second port may take a power path “B” as shown in FIG. 9.

At block 420, the method may allocate power to the first port up to the second value. The method may allocate power to the second port up to the third value. The power adapter may transmit a PDO that includes 5 volts, 9 volts, 15 volts, and 20 volts at 3 amperes to the first device. The power provided via the first port may take a power path “A” as shown in FIG. 9. The power adapter may transmit a PDO that includes 5 volts and 9 volts to the second device plugged into the second port of the power adapter. The power provided via the second port may take a power path “D” as shown in FIG. 9. The first, second, and third values may be pre-defined during the manufacture of the power adapter. In one example, the first value may be set to 60 watts, the second value may be set to 45 watts, and the third value may be set to 15 watts. A firmware of the power adapter, such as in power delivery integrated circuit 915 of FIG. 9 may also be updated to change the first, second, and third values.

FIG. 5 shows a flowchart of a method 500 for intelligent power management of a power adapter. Method 500 may be performed by one or more components of the power adapter, such as a power delivery integrated circuit of 915 of FIG. 9 to monitor and manage power delivery or power allocation to one or more ports of the power adapter. While embodiments of the present disclosure are described in terms of the circuitry of power adapter 900 as shown in FIG. 9, it should be recognized that other systems may be utilized to perform the described method. One of skill in the art will appreciate that this flowchart explains a typical example, which can be extended to advanced applications or services in practice.

In this example, the power adapter may be configured to allocate a guaranteed power up to the first value and a potential power of up to a potential value. In one example, the potential value can be equal to 75 watts. The potential value is a maximum power that the power adapter can provide for a limited time, such as several seconds or tens of seconds. The potential value may be pre-defined at the time of manufacture and can be changed with a firmware update.

Method 500 typically starts at block 505 where the power adapter may detect a first device plugged into a first port and/or a second device plugged into a second port of the power adapter. The method proceeds to block 510 where the method may allocate power to the first port of the power adapter up to the second value. The method may allocate power to the second port up to the third value. Similar to method 300 and method 400 of FIG. 3 and FIG. 4 respectively, the first, second, and third values may be pre-defined at 60, 45, and 15 watts. The power adapter may transmit a PDO that includes 5 volts, 9 volts, 15 volts, and 20 volts at 3 amperes to the first device. The power adapter may also transmit another PDO that includes 5 volts and 9 volts at 3 amperes to the second device.

The method may proceed to decision block 515, where the method may determine whether the temperature, such as an ambient temperature, of the power adapter is less than a temperature threshold value. In one example, the temperature threshold value may be 85 degrees. The temperature threshold value may be pre-determined during the manufacture of the power adapter. However, this pre-determined value may be updated, such as via a firmware update. If the temperature is less than the temperature threshold value, then the “YES” branch is taken and the method proceeds to block 520. If the temperature is not less than the temperature threshold value, then the “NO” branch is taken and the method proceeds to block 530.

At block 520, the method may send a power delivery discovery identity request to the first device and/or the second device to identify capabilities of the devices. The power adapter may receive a response that may include information associated with the type of product, product identifier, vendor identifier, etc. At decision block 525, the method may determine whether the first device at the first port is a preferred device. If the first device is a preferred device, then the “YES” branch is taken and the method proceeds to block 535. If the first device is not a preferred device, then the “NO” branch is taken and the method proceeds to block 530.

At block 530, the method may allocate power to the first port up to the second value. The method may allocate power to the second port up to the third value. The power adapter may transmit a PDO that includes 5 volts, 9 volts, 15 volts, and 20 volts to the first device. The power adapter may transmit a PDO that includes 5 volts and 9 volts to the second device. Afterwards, the method ends. At block 535, the method may allocate power to the first port up to the first value. The method may allocate power to the second port up to the third value. The power adapter may transmit a PDO that includes 5 volts, 9 volts, 15 volts, and 20 volts at 3 amperes to the first device. The power adapter may transmit a PDO that includes 5 volts and 9 volts at 3 amperes to the second device. Afterwards, the method ends.

FIG. 6 shows a flowchart of a method 600 for intelligent power management of a power adapter. Method 600 may be performed by one or more components of the power adapter, such as a power delivery integrated circuit of 915 of FIG. 9 to monitor and manage power delivery or power allocation to one or more ports of the power adapter. While embodiments of the present disclosure are described in terms of the circuitry of power adapter 900 as shown in FIG. 9, it should be recognized that other systems may be utilized to perform the described method. One of skill in the art will appreciate that this flowchart explains a typical example, which can be extended to advanced applications or services in practice.

In this example, similar to method 500, the power adapter may be configured to allocate a guaranteed power up to the first value and a potential power of up to a potential value. In one example, the potential value can be equal to 75 watts. Method 600 typically starts at block 605 where the power adapter may detect a first device plugged into a first port and/or a second device plugged into a second port of the power adapter.

The method proceeds to block 610, where the method may allocate power to the first port of the power adapter up to a second value. The method may allocate power to the second port of the power adapter up to a third value. Similar to method 300 and method 400 of FIG. 3 and FIG. 4 respectively, the first, second, and third values may be pre-defined at 60, 45, and 15 watts. The power adapter may transmit a PDO that includes 5 volts, 9 volts, 15 volts, and 20 volts at 3 amperes to the first device. The power adapter may also transmit another PDO that includes 5 volts and 9 volts at 3 amperes to the second device.

The method proceeds to block 615, where the method may send a power delivery discovery identity request to the first device and/or the second device to identify capabilities of the devices. The power adapter may receive a response that may include information associated with the type of product, product identifier, vendor identifier, etc.

At decision block 620, the method may determine whether the first device at the first port is a preferred device. If the first device is a preferred device, then the “YES” branch is taken and the method proceeds to decision block 630. If the first device is not a preferred device, then the “NO” branch is taken and the method proceeds to block 625.

At decision block 630, the method may determine whether the first port of the power adapter can support the load requirement of the preferred device. If the first port can support the load requirement of the preferred device, then the “YES” branch is taken and the method proceeds to block 640. If the first port of the power adapter cannot support the load requirement of the preferred device, then the “NO” branch is taken and the method proceeds to block 625.

At block 625, the method may allocate power to the first port up to the second value. The method may allocate power to the second port up to the third value. For example, the power adapter may transmit a PDO that includes 5 volts, 9 volts, 15 volts, and 20 volts at 3 amperes. to the first device. The power adapter may also transmit a PDO that includes 5 volts and 9 volts to the second device. Afterwards, the method ends.

At block 640, the method may allocate power to the first port up to the first value. The method may allocate power to the second port up to the third value. For example, the power adapter may transmit a PDO that includes 5 volts, 9 volts, 15 volts, and 20 volts at 3 amperes to the first device. The power adapter may transmit a PDO that includes 5 volts and 9 volts at 3 amperes to the second device. Afterwards, the method ends.

Methods 300, 400, 500, and 600 may be used in conjunction with each other for managing power allocation to the devices plugged into the power adapter. For example, methods 300 and 400 may be performed upon detecting the devices plugged into the power adapter. Method 500 and 600 may then be used to manage the temperature of the power adapter and power allocation to the plugged in devices by maximizing allocated power.

FIG. 7 shows relationships between the temperature of the power adapter voltage/current and system battery charge level of plugged-in electronic devices. FIG. 7 is annotated with a series of letters A, B, C, and D. Each of these letters represents a stage of one or more operations. Although these stages are ordered for this example, the stages illustrate one example to aid in understanding this disclosure and should not be used to limit the claims. Subject matter falling within the scope of the claims can vary with respect to the order of the operations.

At stage A, a first device, which is a preferred device, may be plugged into port 1 and initially may be allocated with power up to the first value, such as 60 watts at 20 volts and 3 amperes. At stage B, a second device, which is a non-preferred device may be plugged into port 2. The second device may be allocated with power up to the third value, such as 15 watts at 5 volts and 3 amperes. At this point, the power provided by the power adapter to both devices totals a potential 75 watts. The power adapter may be able to sustain this for a short period, such as a few seconds or tens of seconds, as the temperature begins to rise. The power provided to both devices may be maintained until a first temperature threshold is reached. The first temperature threshold is the maximum temperature value that a device can reach before an action to reduce power allocation may be performed.

At stage C, the temperature of the power adapter may have reached the first temperature threshold, which for illustration purposes is set here at 85° C. At this point, there may be a power negotiation between the power adapter and the preferred device. For example, the power adapter may transmit the PDO that includes 5 volts, 9 volts, 15 volts, and 20 volts at a reduced current, such as 2.25 amperes. The preferred device may respond with an RDO that specifies which particular voltage and amperes it requires. In this example, the preferred device may respond with the RDO that specifies 20 volts at 2.25 amperes which is 45 watts. The power adapter may respond with an accept or reject message. The preferred device may then start to draw 45 watts. This may cause the temperature to get lower due to the decrease in power drawn by the preferred device. However, the charging rate of a battery of the preferred device may also be slower because of the decrease in power it draws, as depicted in the change of the slope of the charging slope between the battery charge level at 75% and 85%.

At stage D, the preferred device may reach a second temperature threshold, which for illustration purposes is 70° C. The second temperature threshold is a temperature value that a device can reach after reaching the first temperature threshold before an action to change or increase the power allocation may be performed. At this point, the power adapter may renegotiate the power allocation. For example, the power adapter may transmit the PDO that includes 5 volts, 9 volts, 15 volts, and 20 volts at a reduced current, such as 2 amperes. The preferred device may respond with an RDO that specifies which particular voltage and amperes it requires.

In this example, the preferred device may respond with the RDO that specifies 20 volts at 2.5 amperes which is 50 watts. The power adapter may respond with an accept or reject message. The preferred device may then start to draw 50 watts. This may cause the temperature to get higher. Accordingly, the charging rate of a battery of the preferred device may increase, as depicted in the change of the slope of the charging slope between the system battery charge level at 85% and onwards. One of skill in the art will readily appreciate that the power, voltage, current, and temperature values many modifications are possible in the exemplary power and temperature values without materially departing from the novel teachings and advantages of the embodiments of the present disclosure.

FIG. 8 shows relationships between the temperature of the power adapter voltage/current and system battery charge level of plugged-in electronic devices. In this example, a preferred device is plugged into port 1, and a non-preferred device is plugged into port 2. FIG. 8 is annotated with a series of letters A, B, and C. Each of these letters represents a stage of one or more operations. Although these stages are ordered for this example, the stages illustrate one example to aid in understanding this disclosure and should not be used to limit the claims. Subject matter falling within the scope of the claims can vary with respect to the order of the operations.

At stage A, the power adapter may have allocated power up to the first value to the preferred device plugged into port 1. For example, the power adapter may provide 60 watts at 20 volts and 3 amperes to the preferred device. The power adapter may also allocate power up to the third value to the non-preferred device plugged into port 2. For example, the power adapter may allocate 45 watts at 5 volts and 3 amperes to the non-preferred device. Typically, in this example, the preferred device may be provided with more power options and/or be allocated with higher power than the non-preferred device.

At this point, the power adapter may be providing a total of 75 watts to the preferred device and the non-preferred device. As this power allocation cannot be maintained for longer than a certain period, such as several seconds, the power adapter may renegotiate with the preferred device. For example, the power adapter may send another PDO to the preferred device. The preferred device may respond with another RDO. The renegotiation may result in a change to the power allocation, such as at stage B where the preferred device may be allocated less power. In this example, the preferred device may draw 45 watts at 20 volts and 2.25 amperes. At this point, the total power allocated to both devices is 60 watts. In this example, 60 watts can be provided by the power adapter for an extended period.

As the battery charge level of the preferred device increases, the preferred device may draw or consume less power than the power allocated by the power adapter. For example, the total power consumed by both devices is less than the maximum standard power that can be provided for both devices, such as 60 watts as described above. In this scenario, the power adapter may reallocate the available power to the non-preferred device. For example, at stage C, the power adapter may renegotiate with the non-preferred device. The renegotiation may result in a change in the power allocation. In this example, the power consumption of the first device is 42 watts which is less than its allocated power of 42 watts. The power adapter may renegotiate a new power allocation, wherein power allocated to the non-preferred device may be increased from 15 watts to 18 watts at 9 volts and 2 amperes. Accordingly, the power consumption of both devices may be back to the maximum standard power that can be provided to both devices.

The temperature of the power adapter may continue to increase as the power allocated to both devices may be around a maximum power that the power adapter can sustain, such as 60 watts in this example. However, as the preferred device continues to decrease its power draw, the temperature of the power adapter may also decrease. In this example, the temperature initially rose from 25° C. to 50° C. and slowly decreased to 40° C. The renegotiation may continue until the battery of the preferred device is fully charged. In this example, the power allocated to the preferred device may be 20 watts which is 20 volts at 1 ampere.

FIG. 9 shows a circuit diagram of a power adapter 900. Power adapter 900 may be a dual port power adapter that includes a port 1 and a port 2. Power adapter 900 includes a rectifier circuit 905, a flyback converter 910, a power delivery integrated circuit 915, a buck converter 920, a charging circuit 925, and a charging circuit 940. Flyback converter 910 may be grounded. Power delivery integrated circuit 915 may be connected in series with charging circuit 925 and buck converter 920. Charging circuit 925 includes a metal oxide silicon field effect transistor (MOSFET) 930 and a MOSFET 935. MOSFET 930 and MOSFET 935 may be connected in parallel. Charging circuit 925 may be connected in series to flyback converter 910.

Charging circuit 940 includes MOSFETs 950 and 960. MOSFET 950 may be one MOSFET or two MOSFETs that are connected in series to each other. MOSFET 960 may be one MOSFET or two MOSFETs that are connected in series to each other. MOSFET 950 may be connected in parallel to MOSFET and 960. Charging circuit 940 may be connected in series with buck converter 920.

In this example, the MOSFETs may be used in conjunction with buck converter 920 instead of two buck converters or two flyback converters. By not using a dual flyback converter or a dual buck converter, the present disclosure provides a simplified and efficient circuitry at less cost and smaller dimensions. In addition, by using one buck converter instead of two, concerns associated with electromagnetic interference may be mitigated. The components of power adapter 900 may be implemented in hardware, software, firmware, or any combination thereof. The components shown are not drawn to scale and power adapter 900 may include additional or fewer components. In addition, connections between components may be omitted for descriptive clarity.

Power adapter 900 receives AC electrical power, such as through a power outlet, and converts the AC power to DC power using rectifier circuit 905 in conjunction with flyback converter 910. Buck converter 920 may be configured to step down an input DC voltage from flyback converter 910 to a lower DC output voltage to the ports. For example, if a preferred device is plugged into port 1, then 20 volts may be allocated to port 1 via power path A. At this point, MOSFET 930 may be switched on and MOSFET 935 may be switched off. This allows the current associated with the power path A to flow through MOSFET 930. In addition, MOSFETs 950 and 960 may also be switched off. This may also prevent reverse current from flowing.

If a second device is also plugged into port 2, then 5 volts may also be allocated to port 2 via power path D through buck converter 920. At this point, MOSFET 960 may be switched on and MOSFET 950 may be switched off. This allows the current associated with the power path D to flow through MOSFET 960. In another example, if a preferred device is plugged into port 2, then 20 volts may be allocated to port 2 via power path B. At this point, MOSFET 935 may be switched on and MOSFET 930 may be switched off. This allows the current associated with the power path B to flow through MOSFET 935. In addition, MOSFET 960 may be switched off to prevent current to flow through. If a second device is plugged into port 1, then 5 volts may also be allocated to port 1 via power path C through buck converter 920. At this point, MOSFET 950 may be switched on and MOSFET 960 may be switched off. This allows the current associated with the power path C to flow through MOSFET 950.

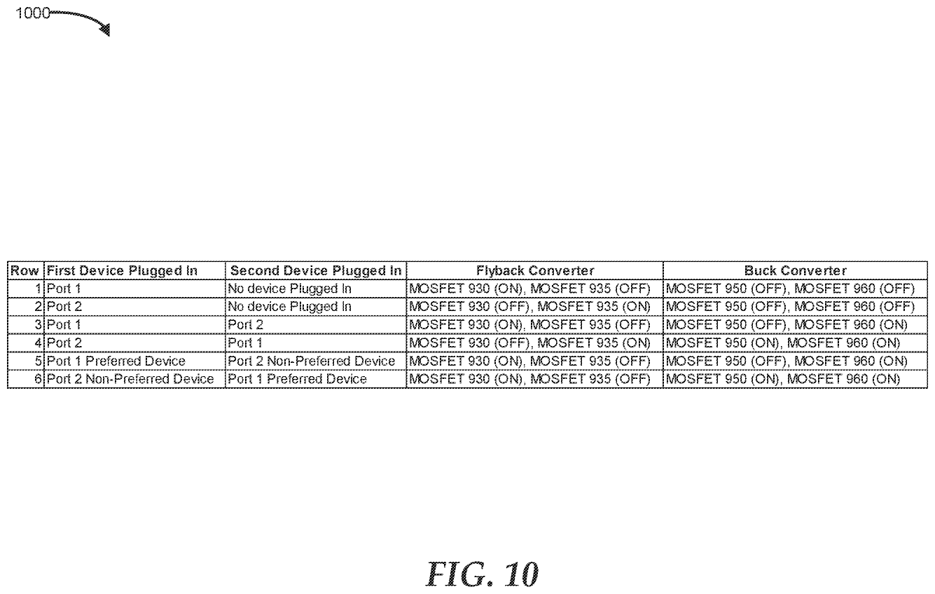

Power delivery integrated circuit 915 may include a non-volatile storage device that includes a firmware that is configured to manage power allocation to the devices plugged into the power adapter as disclosed above. For example, power delivery integrated circuit 915 may switch a MOSFET on or off according to table 1000 of FIG. 10. In addition, power delivery integrated circuit 915 may also be configured to perform operations as disclosed in methods 300, 400, 500, and 600 of FIGS. 3, 4, 5, and 6 respectively.

FIG. 10 shows a table 1000 which includes the status of the MOSFETs based on various states of the ports of the power adapter. The status of the MOSFETs in this table is in reference to the MOSFETs in FIG. 9. Row 1 shows that MOSFET 930 may be switched on while MOSFETs 935, 950, and 960 may be switched off when the first device is plugged into port 1 and no device is plugged into port 2. Row 2 shows that MOSFET 935 may be switched on and MOSFETs 930, 950, and 960 may be switched off when the first device is plugged into port 2 and no device is plugged into port 1. Row 3 shows that MOSFETs 930 and 960 may be switched on and MOSFETs 935 and 950 may be switched off when the first device is plugged in port 1 and then a second device is plugged in port 2.

Row 4 shows that MOSFETs 935, 950, and 960 may be switched on and MOSFET 930 may be switched off when the first device is plugged in port 2 and then the second device is plugged in port 1. Row 5 shows that MOSFETs 930 and 960 may be switched on and MOSFETs 935 and 950 may be switched off when the first device is plugged into port 1, wherein the first device is a preferred device, and the second device is plugged into port 2, wherein the second device is not a preferred device. Row 6 shows that MOSFETs 930, 950, and 960 may be switched on and MOSFET 935 may be switched off when the first device is plugged into port 2, wherein the first device is non-preferred, and the second device is plugged into port 1, wherein the second device is a preferred device.

In various embodiments, power adapter 900 may not include each of the components shown in FIG. 9. Additionally, or alternatively, power adapter 900 may include various additional components in addition to those that are shown in FIG. 9. Furthermore, some components that are represented as separate components in FIG. 9 may in certain embodiments instead are integrated with other components. For example, in certain embodiments, all or a portion of the functionality provided by the illustrated components may instead be provided by components integrated into one or more processor(s) as a system-on-a-chip. It will be understood that the voltage, current, and power values described herein are exemplary. One of skill in the art is that alternative voltage, current, and power values may be used.

Although FIG. 3, FIG. 4, FIG. 5, and FIG. 6 show example blocks of method 300 and method 400 in some implementations, method 300 and method 400 may include additional blocks, fewer blocks, different blocks, or differently arranged blocks than those depicted in FIG. 3, FIG. 4, FIG. 5, and FIG. 6. Those skilled in the art will understand that the principles presented herein may be implemented in any suitably arranged processing system. Additionally, or alternatively, two or more of the blocks of method 300, method 400, method 500, and method 600 may be performed in parallel. For example, block 610 and block 615 of method 600 may be performed in parallel.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

When referred to as a “device,” a “module,” a “unit,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

The present disclosure contemplates a computer-readable medium that includes instructions or receives and executes instructions responsive to a propagated signal; so that a device connected to a network can communicate voice, video, or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes, or another storage device to store information received via carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents but also equivalent structures.

What is claimed is:

1. A method comprising:
in response to detecting that a first device is plugged in to a power adapter, determining whether the first device is a preferred device;
if the first device is the preferred device, then allocating power to the first device up to a first value; and
in response to detecting that a second device is plugged in to the power adapter, then re-allocating power to the first device up to a second value and up to a third value to the second device.

2. The method of claim 1, wherein a manufacturer of the preferred device is the manufacturer of the power adapter.

3. The method of claim 1, further comprising providing power to the first device and the second device until a temperature of the power adapter reaches a temperature threshold value.

4. The method of claim 3, further comprising if the temperature of the power adapter reaches the temperature threshold value, then re-negotiating power allocation to the first device.

5. The method of claim 1, further comprising in response to detecting that the first device is consuming less power than allocated, then increasing the power allocated to the second device.

6. The method of claim 1, wherein the power adapter includes a flyback converter and a buck converter, wherein the buck converter is connected in series to a metal oxide silicon field effect transistor.

7. The method of claim 1, wherein the allocating power to the first device up to the first value is performed by switching on a metal oxide silicon field effect transistor that is associated with a flyback converter of the power adapter.

8. The method of claim 1, wherein the re-allocating power to the first device up to the second value is performed by switching on a metal oxide silicon field effect transistor that is associated with a buck converter of the power adapter.

9. A power adapter comprising:
a flyback converter;
a buck converter; and
an integrated circuit storing instructions that when executed cause the power adapter to perform operations including:
in response to detecting that a first device is plugged in to the power adapter, determining whether the first device is a preferred device;
if the first device is the preferred device, then allocating power to the first device up to a first value; and
in response to detecting that a second device is plugged in, then re-allocating power to the first device up to a second value and up to a third value to the second device, wherein a total of the second value and the third value is up to the first value.

10. The power adapter of claim 9, wherein the operations further comprise providing power to the first device and the second device until a temperature of the power adapter reaches a temperature threshold value.

11. The power adapter of claim 10, wherein the operations further comprise, if the temperature of the power adapter reaches the temperature threshold value, then re-negotiating power allocation to the first device.

12. The power adapter of claim 9, wherein the operations further comprise in response to detecting that the first device is consuming less power than allocated, then increasing power allocated to the second device.

13. The power adapter of claim 9, wherein the buck converter is connected in series to a metal oxide silicon field effect transistor.

14. The power adapter of claim 9, wherein the allocating power to the first device up to the first value is performed by switching on a metal oxide silicon field effect transistor that is associated with the flyback converter of the power adapter.

15. The power adapter of claim 9, wherein the re-allocating power to the first device up to the second value is performed by switching on a metal oxide silicon field effect transistor that is associated with the buck converter of the power adapter.

16. An integrated circuit of a power adapter to store instructions that are executable to perform operations comprising:
determining whether a first device plugged in to a power adapter is a preferred device;
if the first device is the preferred device, then allocating power to the first device up to a first value; and
in response to detecting a second device plugged in, then re-allocating power to the first device up to a second value and a third value to the second device, wherein a total of the second value and the third value is equal to the first value.

17. The integrated circuit of claim 16, wherein the operations further comprise providing power to the first device and the second device until a temperature of the power adapter reaches a temperature threshold value.

18. The integrated circuit of claim 17, wherein the operations further comprise, if the temperature of the power adapter reaches the temperature threshold value, then re-negotiating power allocation to the first device.

19. The integrated circuit of claim 16, wherein the operations further comprise in response to detecting that the first device is consuming less power than allocated, then increasing power allocated to the second device.

20. The integrated circuit of claim 16, wherein the allocating power to the first device up to the first value is performed by switching on a metal oxide silicon field effect transistor that is associated with a flyback converter of the power adapter.
